(19) United States
(12) Patent Application Publication
(10) Pub. No.: US 2023/0304699 A1
(43) Pub. Date: Sep. 28, 2023

(54) Removable secondary air flow orientation device intended to equip a main air duct, duct and air distribution assembly comprising at least one such device, associated air duct and method for assembling such an equipped duct

(71) Applicant: RICHEL GROUP, EYGALIERES (FR)

(72) Inventors: Sylvain Grimault, SAINT-BERTHEVIN (FR); Christophe Tardy, AIX-EN-PROVENCE (FR)

(21) Appl. No.: 18/002,131

(22) PCT Filed: Jun. 18, 2021
(86) PCT No.: PCT/EP2021/066711

§ 371 Date: Dec. 16, 2022

(30) Foreign Application Priority Data
Jun. 19, 2020 (FR) 2006466

(51) Int. Cl. F24F 13/06; F24F 13/08

(52) U.S. Cl. CPC F24F 13/06; F24F 13/084; F24F 2221/14

(57) ABSTRACT

An air orientation device to be coupled to an air discharge opening arranged in a wall of a main air duct. The air orientation device includes a guide portion configured to guide a secondary air flow originating from the discharge opening. and a removable fastener for reversibly fastening the guide portion to the wall of the main air duct.

### 1. TECHNICAL FIELD

The field of the invention is that of systems for conveying fluids, in particular air conditioning systems for greenhouses for growing plants, intended to transport and distribute or diffuse air conditioning in enclosed or semi-enclosed interior volumes, in particular such as greenhouses.

The invention more particularly relates to a new design principle for air conditioning ducts, according to which the ducts are designed to be equipped with removable accessories that are easily arranged during installation, in order to ensure a configurable and optimised secondary air flow distribution.

### 2. PRIOR ART

In order to control the temperature, humidity or ventilation of a building, the use of heating, ventilation and air conditioning systems, commonly referred to as HVAC systems is known. Such air treatment systems conventionally comprise a central air conditioning unit coupled with a network of air ducts for conveying treated (i.e. heated, filtered, cooled, etc.) air to at least one enclosed or semi-enclosed interior volume of the building. Such air ducts further have discharge openings, disposed in a predefined manner, which allow the treated air to pass from the inside to the outside of the air duct. Each discharge opening thus allows secondary air flows, also referred to as discharge air flows hereinbelow, to be created, which are diffused within the interior volume of the building.

When one or more air conditioning ducts supply a greenhouse, the location of the discharge openings, and thus of the secondary air flows discharged along the main duct through these openings, allows a predetermined distribution of the air conditioning in the greenhouse to be achieved, for example in order to obtain the most homogeneous air conditioning possible, despite the sometimes very large size of certain greenhouses, or, on the contrary, in order for the air conditioning to target a specific area.

However, it has been found that when the discharge openings are simple perforations made in a tubular duct, the secondary air flows sometimes take unwanted orientations. More specifically, depending on various parameters, including the position thereof on the duct, some air flows do not project perpendicularly to the axis of the main duct, but tend to have a more or less inclined orientation relative to this longitudinal axis. This effect is potentially increased by the helical mixing produced by the propulsion fans. As a result, it was also found that this phenomenon of inclined discharge air flows led to disparities, in particular in temperature and humidity, within the interior volume to be air-conditioned.

In order to overcome this problem, air ducts are known that have members for orienting the discharge air flows so that these flows can be rectified to flow perpendicular to the longitudinal axis of the air duct.

One conventional solution, applicable to metal air ducts, is to form such orientation members by stamping, with each member being formed by stamping a predetermined portion of the wall of the air duct to obtain a frustoconical impression projecting towards the outside of the air duct, forming a nozzle for orienting the discharge air flow. In the case of flexible air ducts, for example those made of fabric or of a flexible plastic material, such a nozzle for orienting secondary discharge air flows is obtained by fitting a hollow frustoconical element over the discharge opening, then by permanently fastening this frustoconical element to the flexible air duct by means of an adhesive or seam.

However, this solution has several drawbacks. Since the inclined air flow phenomenon only occurs in one or more specific portions of the air duct, this solution requires the use of a plurality of processes for manufacturing the air duct depending on whether or not an orientation nozzle must be fitted. Moreover, it has been found that changing the central air conditioning unit and/or adding or removing an air duct to or from the network in particular can amplify or limit the inclined air flow phenomenon. However, after the air duct has been manufactured using such a multiple process, the arrangement of the orientation nozzles is fixed and can no longer be adapted to the new installation. If a plurality of air duct manufacturing processes are not implemented, the orientation nozzles are fitted throughout the air duct, and thus potentially on portions of the air duct that do not require them. This results in high manufacturing times and costs, as well as an increase in the overall dimensions of the duct.

Another known solution, applicable to both metal air ducts and flexible air ducts, is to make a partial cut in the discharge opening in the air duct, i.e. the ends of the cut do not meet, and then to fold the cut-out portion of the air duct outwards. Once the cut-out portion has been folded back, the discharge opening appears whereas the cut-out portion inherently forms a flap for orienting the discharge air flow. Such orientation flaps have similar drawbacks to the orientation nozzles described hereinabove.

Another known solution, mainly applicable to flexible air ducts, is to form the air duct using two coaxial ducts disposed one inside the other. Each duct comprises discharge openings that are out-of-line with the discharge openings of the other duct. In such a solution, the member for orienting the discharge air flows is formed by one of the coaxial ducts. The use of two coaxial ducts, in addition to causing high head losses resulting in high power consumption, also has drawbacks similar to those of the orientation nozzles described hereinabove.

These solutions thus have various drawbacks, depending on the case, concerning efficiency, overall dimensions, modularity, or cost, etc. There is thus a need for technical solutions that overcome all or some of these drawbacks.

### 3. SUMMARY OF THE INVENTION

According to a first aspect, the proposed technique relates to an air orientation device, intended to be coupled to an air discharge opening produced in a wall of a main air duct, comprising a guide portion configured to guide a secondary air flow originating from the discharge opening.

According to the invention, the characterised air orientation device comprises removable fastening means for reversibly fastening the guide portion to the wall of the main air duct.

Such removable fastening means simplify the installation of the air orientation device on a main air duct. The installation of the air orientation device can more specifically be carried out before or after the main air duct has been installed in an enclosed or semi-enclosed interior volume, such as a greenhouse for growing plants.

Such removable fastening means also allow the positioning of the air orientation device on the main air duct to be changed quickly and easily to suit the user's preferences.

Moreover, the removable fastening means simplify maintenance. The removable fastening means allow for easy removal and replacement of a defective or damaged air orientation device.

According to one specific embodiment, the removable fastening means are configured to exert a local force for immobilising the air orientation device by producing friction on the wall of the main air duct.

Removable fastening means that produce such a frictional force in particular make it possible to ensure that the device is effectively and lastingly fastened to the duct, with little or no degradation of the structure of these two elements. For example, if the main air duct is made of a flexible material, an air orientation device made of a rigid material is preferred. Thus, the frictional force will be primarily due to the deformation of the main flexible air duct by the rigid air orientation device. Conversely, if the main air duct is made of a rigid material, an air orientation device made of a shape-memory material is preferred. Thus, the frictional force will be primarily due to the deformation of the air orientation device by the rigid main air duct.

Moreover, removable friction fastening means allow the air orientation device to be fitted to a wide range of standard and/or pre-existing air ducts without the need for any permanent structural changes thereto, as opposed to, for example, a screwed fastener.

According to another embodiment, the discharge opening and/or the removable fastening means of the air orientation device have a reversible shape-change capability for changing shape between a first position, referred to as a coupling position, which is used for the transitional phase of reversible attachment and/or detachment of the air orientation device with a discharge opening, and a second position, referred to as an immobilisation position, which is taken up continuously when the air orientation device is attached to a discharge opening.

Friction fastening is at least partly due to elastic deformation of the air orientation device and/or of the wall of the main air duct.

According to another embodiment, the removable fastening means are configured to exert a local force for immobilising the air orientation device by pinching the wall of the main air duct.

According to one particular aspect, the removable fastening means comprise at least one blade intended to be engaged with the wall of the main air duct to produce the removable friction fastening.

Advantageously, the removable fastening means comprise at least two, preferably three, blades substantially parallel to one another and extending at least partially in a single fastening plane so as to define a primary blade and at least one secondary blade, said at least two blades being intended to be engaged via an elastic connection with the wall of the main air duct to produce the removable friction fastening.

The primary blade is, for example, intended to be engaged with an outer surface of the wall of the air duct, and the one or more secondary blades are intended to be engaged with an inner surface of the wall of the same air duct, after the secondary blades have been inserted through the air discharge opening. For example, if the air duct is made of a flexible, elastically deformable material, the primary blade allows the wall of the main air duct to be pressed against the secondary blades by a local deformation force deforming the wall. Thus, once the assembly has been assembled, the air orientation device is held together by a frictional force.

Removable fastening means with such a structure allow the guide portion to be reversibly fastened to the wall of the main air duct without the use of tooling. The assembly of the air orientation device on the main duct is thus simple and not very time-consuming for users, even those with little experience.

Such a structure of the removable fastening means further avoids impacting the main air flow flowing inside the main air duct. After assembly, the blades are pressed against and extend along the wall of the duct. Thus, the main air flow can effectively have little or no engagement with the removable fastening means.

According to another particular aspect, the guide portion extends along a longitudinal axis, and the primary blade and said secondary blades are integral with a longitudinal end of the guide portion.

Such a structure of the air orientation device allows the guide portion to have little or no impact on the main air flow flowing inside the main air duct. After assembly, only a reduced part of the guide portion, i.e. that carrying the primary and secondary blades, is located in the interior volume of the main air duct. The air orientation device thus produces little or no head loss in the main air flow.

According to another particular aspect, the guide portion has a tubular shape, and the central blade and said lateral blades extend perpendicular to the longitudinal axis of the guide portion.

The tubular guide portion, which is dimensioned to match the shape and dimensions of the air discharge opening provided in the wall of the main duct, extends the entire inner rim of the air discharge opening (in the same manner as the nozzles of the prior art solutions).

Such a tubular section of the guide portion prevents the need for the air orientation device to be installed in a specific direction on the wall of the main air duct. This in particular results in the air orientation device being easy to install and in an increased durability of the main air duct (by varying the positioning of the removable fastening means).

According to another particular aspect, the air orientation device comprises additional retaining means, typically by abutment or snapping-in, configured to reversibly fasten the guide portion on the wall of the main air duct in a manner that complements said friction fastening.

Such additional retaining means exert a force that is complementary to the frictional force so as to maintain and/or lock the reversible fastening of the guide portion of the air orientation device on the wall of the main air duct. By increasing the number of reversible fastenings, which are achieved by forces of different kinds, the risk of unintentionally extracting the removable fastening means is minimised. For example, in some greenhouses, the main air duct is disposed at eye level. Such additional retaining means thus minimise the risk of a user hitting the duct for example, and tearing off the air orientation device, resulting in particular in irreversible damage to the device and/or the wall of the duct. Such unintentional extractions can in particular be caused by the main air flow circulating inside the main air duct.

Advantageously, the additional retaining means are two projections extending on either side of the guide portion so as to locally widen the guide portion.

Such retaining means allow the guide portion to be locally wider than the diameter of the air discharge opening. Thus, after the retaining means have been inserted into the air duct (for example by elastic deformation of the wall thereof), these retaining means oppose the movements for extracting the air orientation device.

Such retaining means strengthen the reversible fastening in a simple, fast and inexpensive manner.

According to one particular aspect, each of the secondary blades carries one of the projections forming additional retaining means.

Such an arrangement of the additional retaining means simplifies the manufacture of the air orientation device.

According to another specific embodiment, the guide portion has a tubular outer peripheral wall and the removable fastening means comprise two flanges parallel to one another and integral with the outer peripheral wall of the guide portion so as to define an upper flange spaced apart from a lower flange. Moreover, the lower flange has a notch intended to allow the wall of the main air duct to pass between the upper and lower flanges.

Such removable fastening means allow the air orientation device to be assembled to and disassembled from the main air duct and from the outside, by a rotational motion substantially producing the same effect as screwing. More specifically, after having inserted a first end of the lower flange into the air discharge opening of the duct, the user causes the air orientation device to rotate, allowing the wall of the air duct to be gradually inserted between the upper and lower flanges. When this rotation is complete, the wall of the main air duct thus finds itself trapped between the two flanges. Such removable fastening means thus allow for a simple, fast and robust assembly (and disassembly) of the air orientation device on the wall of the main air duct, without the need for tooling.

According to one particular aspect, the flanges are at a distance from one another along the axis of the guide portion and delimit a space therebetween suitable for housing the peripheral edge of the wall of the main air duct.

Thus, after assembly, the wall of the main air duct is disposed, or even pinched, between the lower and upper flanges.

According to one particular aspect, the guide portion has an annular section. This in particular allows for uniform deformation of the air orientation device and/or of the wall of the main air duct.

According to another particular aspect, the lower flange is flush with one end of the guide portion.

Such a structure of the air orientation device allows the guide portion to have little or no impact on the main air flow flowing inside the main air duct. After assembly, only a reduced part of the guide portion, i.e. that carrying the flanges, is located in the interior volume of the main air duct. The air orientation device thus produces little or no head loss in the main air flow.

According to another particular aspect, the air orientation device is made in one piece.

The user thus does not have to carry out one or more operations for assembling the parts that form the air orientation device after these parts have been assembled on the wall of the main air duct. This further prevents the user from misplacing components of the air orientation device and thus having to search for them. This simplifies the assembly and disassembly of the air orientation device.

According to another particular aspect, the lower flange has two free ends, delimiting the notch, and the ends are symmetrical relative to a median plane passing through the axis of the guide portion located between said ends.

Such symmetry in particular simplifies the assembly/disassembly of the air orientation device on the wall of the main air duct by allowing the device to be rotated both clockwise and anticlockwise.

Alternatively, the lower flange has two free ends, delimited by the notch, and the ends are asymmetrical relative to a median plane passing through the axis of the guide portion located between the ends.

Such asymmetry in particular allows the more convergent end, i.e. the end with the longer edge and more gradual trailing edge, to initiate the installation of the air orientation device on the wall of the main duct, whereas the less convergent end minimises the deformation of the wall of the main air duct and simplifies the disassembly of the air orientation device.

Advantageously, said ends converge towards one another in the direction of said outer peripheral wall of the guide portion.

In other words, the ends of the free edges thereof are closer to one another in the vicinity of the outer peripheral wall of the guide portion, whereas the free edges thereof move away from one another starting from the outer peripheral wall of the guide portion towards the peripheral edge of the flange.

Advantageously, the ends of the lower flange are convex in shape.

Such a shape of the ends minimises the risk of degradation to the flexible wall of the main duct and/or the air orientation device. This makes the main air duct and/or the air orientation device highly durable.

According to a second aspect, the proposed technique relates to a duct and air distribution assembly comprising:
a main air duct, the wall whereof has a plurality of secondary air discharge openings therethrough; and,
at least one secondary air orientation device coupled to one of the discharge openings, each air orientation device comprising a guide portion for guiding a secondary air flow originating from the discharge opening associated with the air orientation device and removable fastening means for removably fastening the guide portion to the wall of the air duct.

Such removable fastening means allow the air orientation device to be installed on the air duct and the positioning thereof to be modulated and adapted to suit the user's preferences. Such an assembly allows the user to position the air orientation devices after the air duct has been installed, i.e. after coupling to a central air conditioning unit or connection to the network of air ducts. Such an assembly thus allows the user to choose to which air discharge openings he/she wishes to fit a removable air orientation device, in particular depending on the blowing conditions.

Furthermore, air orientation devices comprising such removable fastening means allow the overall dimensions of the assembly to be minimised, for example for the storage thereof, and simplify handling. By disconnecting the air orientation devices, the main air duct can be easily installed in an enclosed or semi-enclosed interior volume without the risk of damaging one or more air orientation devices, for example.

According to one specific embodiment, the removable fastening means comprise at least two, preferably three, blades substantially parallel to one another and extending at least partially in a single fastening plane, so as to define a primary blade and at least one secondary blade, and the primary blade is elastically connected to an outer surface of the wall of the main air duct and said at least one secondary blade is elastically connected to an inner surface of the wall of the air duct.

According to one particular aspect, the main air duct is configured to transport a main air flow in a predefined direction, and the primary blade and said at least one secondary blade are oriented in the predefined direction of the main air flow.

Such an orientation of the blades prevents the main air flow flowing inside the air duct from causing the air orientation device to be extracted unintentionally. Conversely, such an orientation ensures the reversible fastening of the air orientation device on the wall of the main air duct. The main air flow more specifically presses the guide portion against the inner rim of the air discharge opening.

According to another particular aspect, the plurality of discharge openings are distributed along the main air duct having a predetermined length, and each discharge opening located in a first longitudinal area of the main air duct carries an air orientation device.

Such an arrangement of the air orientation devices allows the entirety of the secondary air flows to be rectified in a specific area of the main air duct that is subjected to the inclined discharge air flow phenomenon. Such an arrangement thus reduces the costs of the duct and distribution assembly, in particular by avoiding the need to install air orientation devices on areas of the main air duct in which the inclined discharge air flow phenomenon is little or not at all present.

Advantageously, the first longitudinal area has a length comprised between one fifth and one half of the length of the main air duct, and the first longitudinal area is located at a longitudinal end of the main air duct, the longitudinal end of the main air duct being intended to be coupled to a central air conditioning unit.

Such an arrangement of the air orientation devices allows the entirety of the secondary air flows of the area of the main air duct the most affected by the inclined discharge air flow phenomenon to be rectified, i.e. in the area directly at the outlet of the air conditioning unit. The length of the first longitudinal area is evidently dependent on the blowing conditions.

According to another advantageous aspect, the main air duct comprises a second longitudinal area, which is separate from the first longitudinal area, wherein certain discharge openings respectively carry an air orientation device, and a third longitudinal area, which is separate from the first and second longitudinal areas, wherein the discharge openings are devoid of any air orientation device.

Advantageously, the first, second and third areas are in succession. Since the inclined discharge air flow phenomenon gradually fades as the main air flow propagates within the main air duct, not all discharge openings need to be equipped with air orientation devices. Such a regressive arrangement of the air orientation devices further minimises the costs of the assembly, in particular by avoiding air orientation devices from being installed in areas of the main air duct that are not subjected to the inclined discharge air flow phenomenon.

According to a third aspect, the proposed technique relates to an air duct of the type intended for use in a duct and distribution assembly as described hereinabove.

The proposed technique further relates to a method for assembling a duct and distribution assembly as described hereinabove according to a particular aspect, comprising the following steps of:
inserting, from outside the main air duct, at least one secondary blade through the secondary air discharge opening;
engaging the primary blade with an outer surface of the wall of the main air duct and engaging said at least one secondary blade with an inner surface of the wall of the main air duct; and
sliding the primary blade and said at least one secondary blade along the wall of the main air duct until the guide portion abuts against a rim of the associated secondary air discharge opening.

Such a method allows for a simple, efficient and time-saving assembly of an air orientation device according to one specific embodiment of the proposed technique.

### 4. LIST OF FIGURES

Other features and advantages of the invention will be better understood upon reading the following description, which is given as a rough guide and in no way as a limited guide, with reference to the accompanying drawings, in which:

FIG. 1A to 1F show, from different views, an example of a reversibly-fastened air orientation device according to a first embodiment of the proposed technique;

FIG. 2 shows a partial perspective view of an example of a duct and air distribution assembly having a main air duct equipped with a plurality of reversibly-fastened air orientation devices according to the first embodiment of the proposed technique;

FIG. 3, which is a sectional view of FIG. 2, illustrates an example of the angular positioning of the secondary air discharge openings on the periphery of the main air duct;

FIG. 4 shows a side view of an example of a longitudinal distribution of the reversibly-fastened air orientation devices on the secondary air discharge openings of the main air duct;

FIGS. 5A and 5B illustrate the positioning of the removable fastening means for removably fastening a secondary air orientation device on the wall of the main air duct;

FIG. 6 shows a longitudinal and partial sectional view of an assembly according to FIG. 2, the function of orienting and guiding a secondary air flow being performed by a secondary air orientation device according to the proposed technique;

FIGS. 7A and 7B show, from different views, an example of a reversibly-fastened air orientation device according to a second advantageous embodiment of the proposed technique;

FIG. 8 shows a perspective view of an example of a reversibly-fastened air orientation device according to a third advantageous embodiment of the proposed technique;

FIG. 9 diagrammatically shows an example of the removable fastening means according to a fourth advantageous embodiment of the proposed technique;

FIGS. 10A and 10B show, from different views, an example of a reversibly-fastened air orientation device according to a fifth embodiment of the proposed technique;

FIGS. 11A and 11B show, from different perspective views, an example of a reversibly-fastened air orientation device according to a sixth embodiment of the proposed technique;

FIGS. 12A and 12B each show an example of a reversibly-fastened air orientation device according to a seventh embodiment of the proposed technique;

FIGS. 13A and 13B illustrate distributions of the secondary air discharge openings provided in the main air duct that are an alternative to that shown in FIG. 3; and

FIG. 14 shows a diagrammatic top view of an example of the distribution of the reversibly-fastened air orientation devices on the secondary air discharge openings that is an alternative to that shown in FIG. 4.

### 5. DETAILED DESCRIPTION OF THE INVENTION

The same elements are denoted hereinbelow by the same reference numerals in the different figures.

### 5.1 General Principle

The proposed technique is based on a novel approach to the design and implementation of air orientation devices having a guide portion that provides predetermined guidance of secondary (or “bypass”) air from a main air flow flowing in a main air duct. This type of secondary air orientation device is intended to be coupled to an air discharge opening provided in the wall of the main air duct. The novel technique of the invention has different embodiments which can be implemented depending on whether the wall of the main duct is made of a rigid material or a flexible, elastically-deformable material.

The invention in particular implements removable fastening means for reversibly fastening the guide portion to the wall of the main air duct.

The proposed technique further relates to a duct and air distribution assembly comprising:
a main air duct, the wall whereof has a plurality of secondary air discharge openings therethrough; and,
at least one secondary air orientation device coupled to one of the discharge openings, each air orientation device comprising a guide portion for guiding a secondary air flow originating from the discharge opening associated with the secondary air orientation device and removable fastening means for removably fastening the guide portion to the wall of the main air duct.

Such removable fastening means thus simplify the assembly, and the modulation and/or modification of the positioning of a secondary air orientation device on a main air duct to suit the user's preferences, without degrading the structure of the air duct carrying the air orientation device.

In order to be implemented on a wide range of standard and/or pre-existing air ducts without requiring structural modifications thereto, the reversible fastening is preferably achieved by a local force immobilising the air orientation device by friction on the wall of the main air duct. Such a frictional force is obtained by a local deformation, more specifically an elastic deformation, of the wall of the main air duct and/or the removable fastening means.

Such a friction fastening can be achieved by means of removable fastening means having various materials and/or structures, some of which are described hereinbelow for illustration purposes only.

### 5.2 Description of an Exemplary Embodiment

### 5.2.1 Removable Air Orientation Device

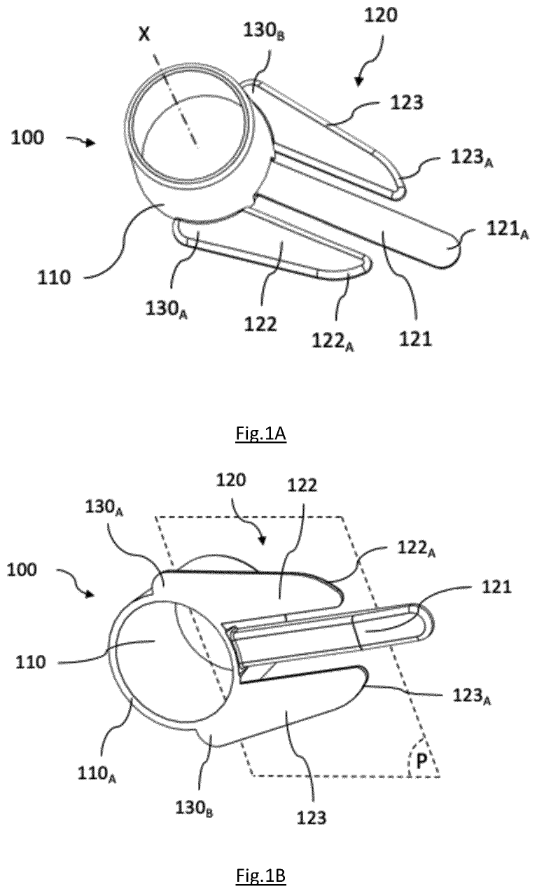

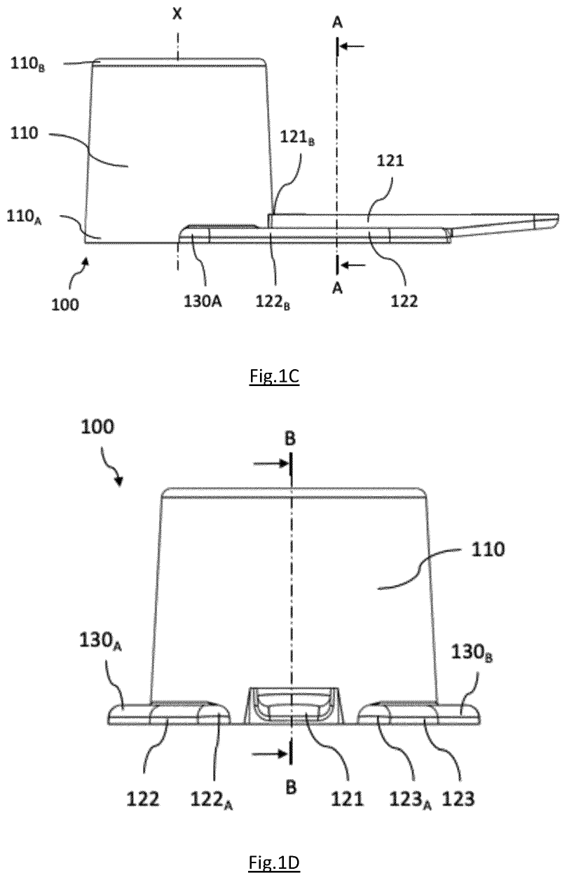

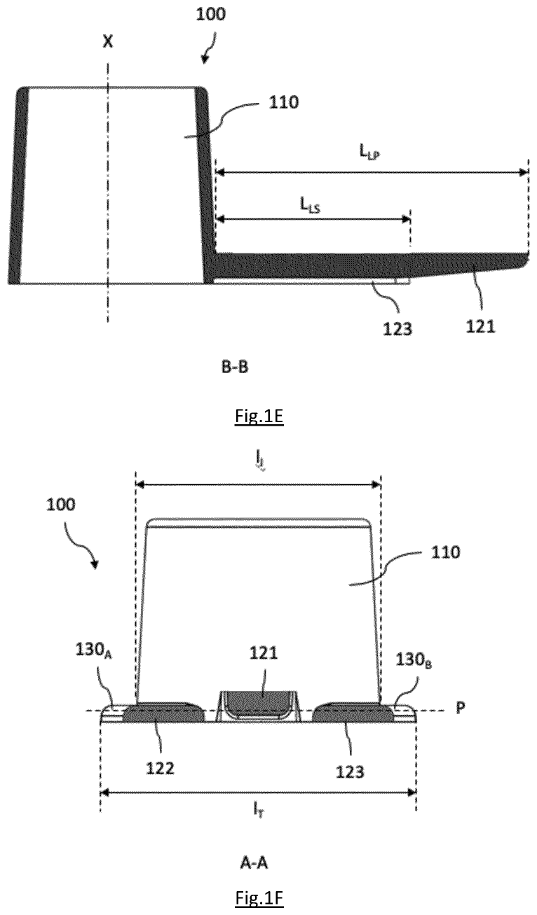

FIG. 1A to 1F show, from different views, an example of an air orientation device according to a first embodiment of the proposed technique.

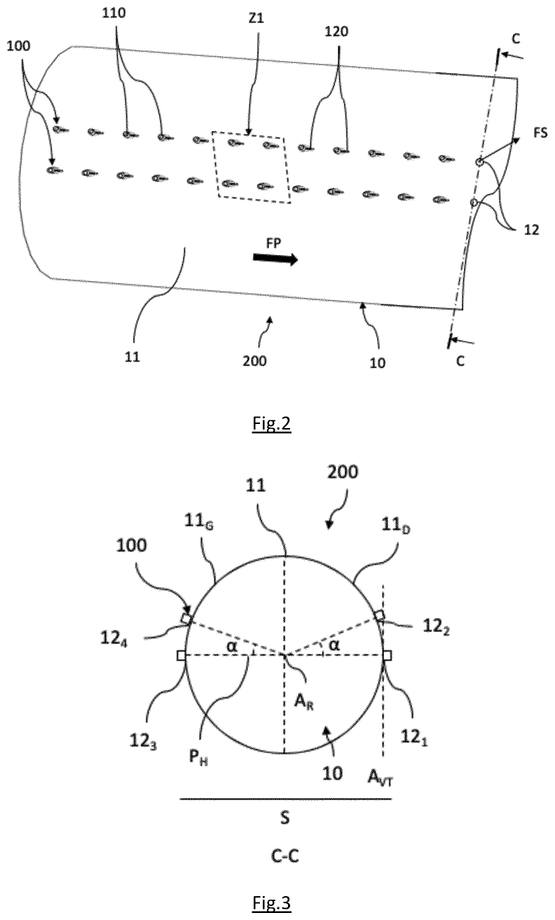

The air orientation device 100, which is intended to be coupled to an air discharge opening 12 provided in a wall 11 of a main air duct 10, as illustrated in particular in FIG. 2, comprises a guide portion 110 intended to guide and orient a secondary air flow originating from the discharge opening 12 associated with the air orientation device 100.

According to the proposed technique, the air orientation device 100 comprises removable fastening means 120, integral with the guide portion 110, intended to reversibly fasten the guide portion 110 to the wall of a main air duct 10.

To this end, the removable fastening means 120 are configured to exert a local force for immobilising the air orientation device 100 by producing friction on said wall of the main air duct.

Moreover, the air orientation device 100 comprises additional retaining means 130_{A}, 130_{B}, for example by abutment, snapping-in or screwing, configured to procure or strengthen the reversible fastening of the guide portion 110 on the wall 11 of the main air duct 10. In other words, such additional retaining means 130_{A}, 130_{B} allow the reversible fastening of the guide portion 110 on the wall 11 of the main air duct 10 to be maintained and/or locked so as to prevent any unintentional removal of the removable fastening means 120.

In the example illustrated, the air orientation device 100 is made in one piece from a rigid material which advantageously has the following properties: high resistance to corrosion, chemical agents, ultraviolet rays, sufficient flexibility to allow for insertion through the wall, and a high mechanical strength. Preferably, the air orientation device 100 is made of a rigid macromolecular plastic material having such properties. Also preferably, the air orientation device 100 is made of a thermoplastic material, so as to be manufactured by injection moulding or printing, having such properties inherently and/or by way of further treatment. Thus, in the example shown, the air orientation device 100 is made of polyethylene terephthalate. However, any other plastic material with such properties, such as polypropylene, polyoxymethylene or a polyamide for example, can also be considered.

According to another solution, the air orientation device 100 can be made in one piece from a metal material which has the above properties inherently and/or by way of treatment. For example, the air orientation device 100 is made of stainless steel 304, aluminium 5086 or brass. An air orientation device made of a metal material can be considered in particular when the wall of the main air duct is thick enough to prevent any risk of being torn by the device.

According to yet another solution, the air orientation device 100 that must cooperate with a wall made of a rigid material, is made of a shape-memory material with elastic properties, such as polyurethane for example.

As illustrated, the guide portion 110 is tubular in shape, extending along a longitudinal axis X, and has an annular cross-section. The guide portion 110 has a first longitudinal end 110_{A} and a second longitudinal end 110_{B}, opposite the first longitudinal end 110_{A}. The guide portion 110 has an outer diameter that is equal to or substantially greater than the diameter of the circular discharge opening intended to receive the air orientation device 100.

Such a dimensioning and such a geometry of the guide portion 110 do away with the need to install the air orientation device 100 in a specific direction on the wall of the main air duct, in order for it to carry out its function of orienting and guiding the associated secondary air flow. In other words, the function of orienting and guiding the associated secondary air flow is achieved regardless of the angular position of the guide portion and regardless of the tangential component of the velocity of the main air flow reaching the secondary air discharge opening.

More specifically, the guide portion 110 is advantageously a hollow frustoconical tube whose largest diameter, corresponding to the first longitudinal end 110_{A}, is equal to or substantially greater than the diameter of the discharge opening that must receive the air orientation device 100. Preferably, the guide portion 110 has substantially identical maximum outer diameter and length values.

By mechanically coupling the first (wider) longitudinal end 110_{A} of the guide portion 110 to the discharge opening 12, as illustrated in FIG. 6 in particular, the frustoconical shape, which reduces in diameter as it moves away from the main duct, allows the flow rate in the guide portion guiding the secondary air flow originating from this discharge opening to be significantly reduced.

Moreover, in this preferred embodiment, the removable fastening means 120 consist of three blades 121, 122, 123 having respectively a free first longitudinal end 121_{A}, 122_{A}, 123_{A} and a second longitudinal end 121_{B}, 122_{B}, 123_{B} that is integral with the guide portion 110. More specifically, the blades 121, 122, 123 are integral with the first wide end 110_{A} of the guide portion 110 and extend perpendicular to the longitudinal axis X of the guide portion 110. In other words, the blades 121, 122, 123 locally and radially extend the wide end 110A of the guide portion 110.

The blades 121, 122, 123 are spaced apart from one another, substantially parallel to one another and extend at least partially in a single fastening plane P, as illustrated in particular in FIGS. 1B and 1F. Advantageously, the blades 121, 122, 123 extend in the same direction from the guide portion 110.

Thus, in this embodiment, the removable fastening means 120 comprise a primary blade 121, referred to as the central blade, and two secondary blades 122, 123, referred to as the lateral blades. The lateral blades 122, 123 are disposed symmetrically relative to the central blade 121 to simplify the installation of the air orientation device on the main air duct.

More specifically, the central blade 121 is intended to be engaged with an outer surface 11_{E} of the wall 11 of the main air duct 10, whereas the lateral blades 122, 123 are intended to be engaged with an inner surface 11_{I} of the wall 11 of the same main air duct 10, as illustrated in particular in FIG. 6.

The first longitudinal ends 122_{A}, 123_{A} of the lateral blades 122, 123 respectively, which are symmetrical relative to the central blade 121, form partially rounded tips. Such tips allow the free longitudinal ends 122_{A}, 123_{A} of the lateral blades 122, 123 to be narrower than the guide portion 110, as illustrated in FIG. 1D, so as to simplify the insertion of the secondary blades 122, 123 into a discharge opening.

Furthermore, FIG. 1E shows in particular that the primary blade 121 has a length L_{LP} of a first predetermined value and that the secondary blades 122, 123 respectively have a length L_{LS} of a second predetermined value, which is less than the predetermined value of the length L_{LP} of the primary blade 121.

Such a dimensioning of the primary blade 121 and secondary blades 122, 123 simplifies the installation of the air orientation device 100 on the wall of the air duct 10. Such a difference in the length of the blades more specifically allows the primary blade to be easily deformed (elastically). Thus, by pressing, in a non-recurrent manner, the free end 121_{A} of the primary blade 121 against the outer surface 11_{E} of the wall 11 of the main air duct 10, the primary blade 121 is temporarily moved away from the secondary blades 122, 123. The primary blade 121 thus forms a guide element simplifying the insertion of the secondary blades 122, 123 through the discharge opening 12.

In the example illustrated, the primary blade 121 has a length L_{LP} of 3 cm and the secondary blades 122, 123 respectively have a length L_{LS} of 2 cm. It goes without saying that the dimensions of the primary and secondary blades are adjustable.

Moreover, additional retaining means 130_{A}, 130_{B} are provided in the form of two projections extending on either side of the guide portion 110 so as to locally widen the latter. More specifically, the projections 130_{A}, 130_{B} extend at least partially in the fastening plane P, as illustrated in particular in FIG. 1F.

Thus, the projections 130_{A}, 130_{B} allow the guide portion 110 to locally have a total width I_{T} that is greater than the initial width I_{I} of the guide portion 110. The term “initial width” in this embodiment refers to the diameter of the wide end 110_{A} of the frustoconical guide portion 110.

In the illustrated example, the projections forming the additional retaining means 130_{A}, 130_{B} are carried by the lateral blades 121, 122.

According to another solution, the additional retaining means can be formed by snap-in elements. According to yet another solution, the additional retaining means can be formed by a fastening member, typically a rivet, passing through the central blade and the wall of the duct to make these two elements integral with one another.

5.2.2 Duct and Air Distribution Assembly Equipped with Removable Air Orientation Devices

FIG. 2 shows a partial perspective view of an example of a duct and air distribution assembly according to the invention, comprising a main air duct, provided with secondary air discharge openings, equipped with a plurality of secondary air orientation devices according to the first embodiment of the proposed technique as described hereinabove.

The duct and distribution assembly 200 comprises a main air duct 10, having a wall 11, inside which flows a main air flow FP generated by a central air conditioning unit (visible in FIG. 4) coupled to one of the ends of the main air duct 10.

The duct and distribution assembly 200 further comprises a plurality of secondary air orientation devices 100, each coupled to a discharge opening 12, and in accordance with the proposed technique. In other words, each air orientation device 100 comprises, on the one hand, a guide portion 110 for guiding a secondary air flow, originating from the discharge opening 12 associated with the secondary air orientation device 100, and on the other hand, removable fastening means 120 for removably fastening the guide portion 110 to the wall 11 of the main air duct 10.

As illustrated, the main air duct 10 advantageously has a tubular shape, with an annular section, extending along a longitudinal axis corresponding to the axis of revolution A_{R} of the main air duct 10.

Moreover, the main air duct 10 comprises a wall 11 made of a flexible material, through which a plurality of circular air discharge openings 12 are provided.

In the example provided by way of non-limiting illustration, the wall 11 is made of a flexible plastic, such as polyethylene for example. According to another solution, the wall 11 can be made of fabric.

Moreover, the discharge openings 12 are distributed along the main air duct 10 at constant intervals and each discharge opening 12 is configured to have a secondary air flow FS pass therethrough so as to be diffused in a predetermined direction within an enclosed or semi-enclosed interior volume such as that of a greenhouse for growing plants. According to another solution, the discharge openings 12 can, however, be distributed along the main air duct at varying intervals, for example at increasing intervals or according to another specific distribution rule, in particular so as to optimise the distribution of the secondary air distribution within an enclosed or semi-enclosed interior volume.

Furthermore, in this example, the air orientation devices 100 are in accordance with the first embodiment of the proposed technique.

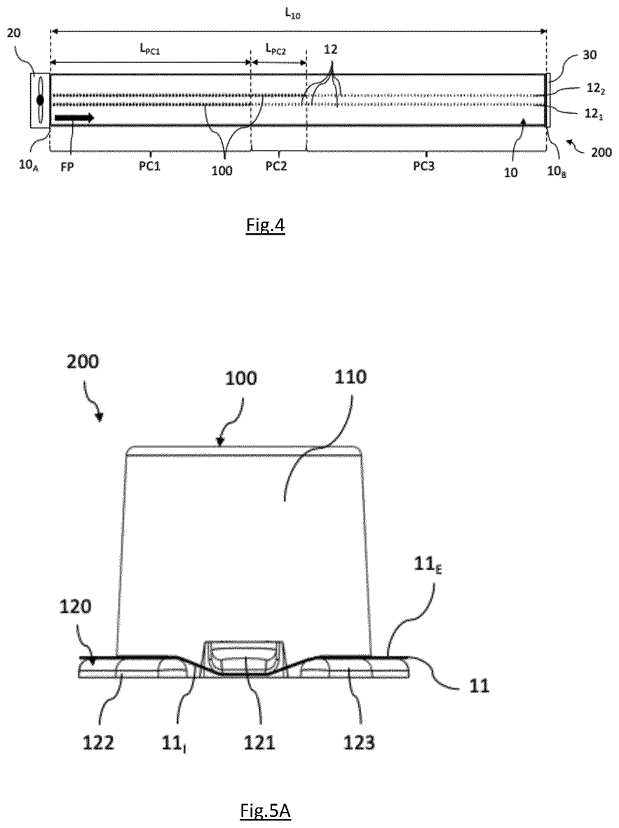

FIG. 3 is a cross-sectional view along the C-C plane of an advantageous embodiment of a duct and air distribution assembly as described with reference to FIG. 2, and illustrates an example of the angular positioning of the secondary air discharge openings on the periphery of the main air duct, and thus ultimately that of all or part of the secondary air orientation devices.

The main air duct 10, which is tubular in shape and has an annular section, has an axis of revolution A_{R} that extends in a horizontal plane P_{H}, parallel to the ground S, after the assembly has been installed in an enclosed or semi-enclosed interior volume.

Each secondary air discharge opening 12 is provided in the wall 11 of the main air duct 10 in at least one sector of angle α to the horizontal plane P_{H}. The angle α is comprised between 0° and 45°, preferably between 0° and 30°.

As illustrated, the main air duct 10 has four sets of discharge openings 12₁, 12₂, 123, 124 distributed along the wall 11. It goes without saying that the number of sets of discharge openings can be adjusted to suit the user's needs.

The main air duct 10 has first and second sets of discharge openings 12₁, 12₂ provided in a right-hand lateral portion 11_{D} of the wall 11. Each of the first and second sets of discharge openings 12₁, 12₂ is provided in an angular sector of approximately 25°, located in the upper part of the wall 11, i.e. above the horizontal plane P_{H}. Even more specifically, the first set of discharge openings 12₁ is provided at an angle of 0° to the horizontal plane P_{H} and the second set of discharge openings 12₂ is provided at an angle of 25° to the horizontal plane P_{H}.

Similarly, the main air duct 10 has third and fourth sets of discharge openings 12₃, 12₄ provided in a left-hand lateral portion 11G of the wall 11. Each of the third and fourth sets of discharge openings 12₃, 12₄ is provided in an angular sector of approximately 25°, located in the upper part of the wall 11, i.e. above the horizontal plane P_{H}. Even more specifically, the third set of discharge openings 12₃ is provided at an angle of 0° to the horizontal plane P_{H} and the fourth set of discharge openings 12₄ is provided at an angle of 25° to the horizontal plane P_{H}. In other words, the air discharge openings are symmetrically distributed relative to a vertical plane passing through the axis of revolution A_{R} of said duct.

Such an arrangement of the secondary air discharge openings 12 in particular minimises the risk of unintentionally extracting or tearing away the air orientation devices when users pass close to the main air duct. This is especially true when the air discharge openings, and thus the associated air orientation devices, are located away from a vertical axis A_{VT} tangent to the outer rim of the duct wall at the main air duct 10, i.e. when the air discharge openings are located at a distance from the horizontal plane P_{H}.

Obviously, the person skilled in the art will know how to adapt the arrangement of the secondary air discharge openings 12 in particular as a function of the diameter of the main air duct and/or the location thereof in an enclosed or semi-enclosed interior volume.

FIG. 4 is a diagrammatic view in a longitudinal plane of an advantageous embodiment of an installation comprising a duct and air distribution assembly according to the proposed technique. This figure shows an example of a longitudinal distribution of the secondary air orientation devices on secondary air discharge openings along the main air duct.

The installation comprises a central air conditioning unit 20 mechanically and fluidly coupled to a first longitudinal end 10_{A} of the main air duct 10 and a cover 30 mechanically and fluidly coupled to a second longitudinal end 10_{B}, opposite the first longitudinal end 10_{A}, of the main air duct 10.

The central air conditioning unit 20 is configured to generate a main air flow FP of treated air flowing within the main air duct 10.

The cover 30 is configured to prevent the main air flow FP from exiting through the second longitudinal end 10_{B} of the main air duct 10, or at least to limit the escape of this air flow if air discharge ports are provided therethrough for example. In other words, the cover 30 allows the main air flow FP to be discharged into the enclosed or semi-enclosed interior volume through the air discharge openings 12 intended for this purpose.

The main air duct 10, of predetermined length L₁₀, has a plurality of air discharge openings 12 divided into different sets of discharge openings (of which only the first and second sets of discharge openings 12₁, 12₂ are visible) extending along the longitudinal axis of the air duct 10 and over the entire length thereof. It should be noted, however, that the invention does not rule out the case where only a part of the duct is equipped with openings.

More specifically, in the embodiment shown, the main air duct 10 is organised, i.e. tiered, or notionally cut, into several successive longitudinal portions or areas, each area comprising a determined configuration of discharge openings 12. In a determined longitudinal area, the determined configuration of the discharge openings 12 corresponds to sub-sets of the discharge openings respectively originating from the different sets of discharge openings (of which only the first and second sets of discharge openings 12₁, 12₂ are visible).

In this way, each longitudinal portion or area of the duct can have a specific configuration for the openings on the one hand, and for the air orientation devices 100 on the other hand, in order to comply with optimal and configurable patterns of optimal distribution of the treated air within the enclosed or semi-enclosed interior volume, i.e. typically a greenhouse for growing plants.

In the illustrated example, the main air duct 10 is notionally separated into three longitudinal areas or portions, i.e. a first longitudinal area PC1, a second longitudinal area PC2, succeeding the first longitudinal area PC1, and a third longitudinal area PC3, succeeding the second longitudinal area PC2.

In the first longitudinal area PC1, located at the first longitudinal end 10_{A} of the air duct 10, each (non-visible) air discharge opening is equipped with an air orientation device 100. The first longitudinal portion PC1 has a length L_{PC1} comprised between one fifth and one half of the length L₁₀ of the main air duct 10.

In the second longitudinal area PC2, only some of the discharge openings 12 are equipped with air orientation devices 100. As illustrated, only the discharge openings 12 belonging to the second set of discharge openings 12₂ are equipped with air orientation devices 100. The second longitudinal portion PC2 has a length L_{PC2} corresponding substantially to one tenth of the length L₁₀ of the main air duct 10.

In the third longitudinal area PC3, all discharge openings 12 are devoid of air orientation devices.

It was found that the inclined secondary air flow phenomenon, creating “hot spots” in the enclosed or semi-enclosed interior volume, occurs mainly at the outlet of the central air conditioning unit and then diminishes as the primary air flow propagates through the primary air duct.

The new distribution of the air orientation devices on the main air duct, as permitted by the invention, thus allows the areas where the secondary air flows must be rectified to be targeted. More generally, the new design of both the main air ducts and their equipment accessories, i.e. the secondary air orientation devices, provides for broader installation possibilities for the duct and air distribution assemblies and simplifies the implementation thereof. In particular, during installation, the design of the ducts and devices makes it possible to limit material and human resources, in particular the number of air orientation devices and thus the time required to install same, while effectively treating the air. This thus results in a reduction in the production costs of the assembly.

Moreover, the removable nature of the air orientation devices according to the invention facilitates not only the targeted installation thereof, but also the removal or displacement thereof. For example, in the same greenhouse for growing plants, it will be very easy to set up other distributions of the air orientation devices on the main air duct, in particular as a function of the power of the air conditioning unit and/or the configuration of the main air duct (which can be integrated into a network of air ducts for example).

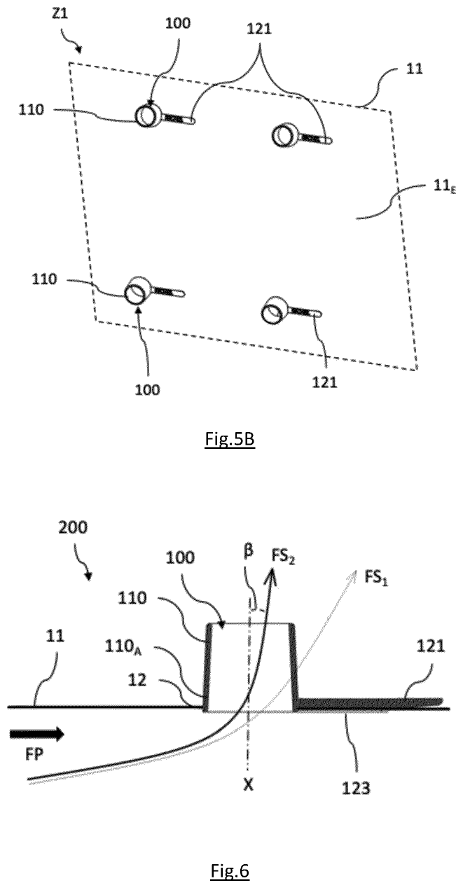

FIG. 5A is a partial, sectional view of a secondary air orientation device according to the invention, and of the positioning thereof on the wall of the main air duct after assembly, and of the interactions thereof as part of a duct and distribution assembly according to FIG. 2. FIG. 5B, which is a focused view of an area Z1 of the wall of the main air duct of a duct and distribution assembly according to FIG. 2, also shows such interactions.

As illustrated, the central blade 12₁ of the removable fastening means 120 is engaged with an outer surface 11_{E} of the wall 11 of the main air duct 10, and the lateral blades 122, 123 are engaged with an inner surface 11_{I} of the wall 11 of the same main air duct 10.

Due to the fact that the central blade 121 and lateral blades 122, 123 extend partially in the same fastening plane P, such an arrangement of the removable fastening means 120 on the wall 11 of the main air duct 10 allows a local deformation of the wall 11 of the main air duct 10 to be created. This local deformation, which creates tension in the wall, allows a frictional force to be generated between the wall 11 of the main air duct and the central blade 121 and lateral blades 122, 123 that is sufficient to immobilise the assembly.

The local deformation of the wall 11 of the main air duct 10 further allows the diameter of the discharge opening 12 to be reduced. Thus, the contour of the discharge opening is more tightly clamped against the guide portion 110 of the air orientation device 100. This improves the holding of the air orientation device 100 on the main air duct 100 and produces the seal between these two elements.

FIG. 6 is a partial, longitudinal sectional view of a duct and distribution assembly according to FIG. 2, and illustrates the function of orienting and guiding a secondary air flow performed by a secondary air orientation device according to the proposed technique.

The arrow shown by way of a thin line represents the direction of a first secondary air flow FS₁ originating from a secondary air discharge opening 12 devoid of any secondary air orientation device in accordance with the proposed technique.

The arrow shown by way of a bold line represents the direction of a second secondary air flow FS₂ originating from the same secondary air discharge opening 12 after fastening a secondary air orientation device 100 in accordance with the proposed technique.

It can thus be seen that the guide portion 110 of the air orientation device 100 allows the second secondary air flow FS₂ to be rectified so as to form an angle β relative to an axis perpendicular to the direction of flow of the main air flow FP inside the wall 11. In the illustrated embodiment, this perpendicular axis substantially corresponds to the longitudinal axis X of the guide portion 110.

More specifically, the guide portion 110 is configured to define an angle β comprised between 0° and 20°, preferably 10°. Such values of the angle β allow the “hot spot” phenomenon caused by the inclined air flows (represented by the first secondary air flow FS₁) to be considerably reduced or even eliminated.

Furthermore, FIG. 6 highlights the fact that the central blade 121 and lateral blades, of which only the lateral blade 122 is visible, are oriented in the direction of the main air flow FP inside the main air duct 10. It goes without saying that other orientations of the blades can be envisaged insofar as the guide portion procures a function of orienting and guiding the secondary air flow. For example, the blades can be oriented perpendicular to the longitudinal axis of the main air duct such that they are oriented towards a left- or right-hand side of the duct.

5.2.3 Method for Assembling a Duct and Air Distribution Assembly Equipped with Removable Air Orientation Devices

The method for assembling a duct and air distribution assembly, as described with reference to FIGS. 2 to 6, comprises the following steps of:
inserting, from outside the main air duct 10, lateral blades 122, 123 through a secondary air discharge opening 12;
engaging the central blade 121 with an outer surface 11_{E} of the wall 11 of the main air duct and engaging the lateral blades 122, 123 with an inner surface 11_{I} of the wall 11 of the main air duct 10; and
sliding the central blade 121 and lateral blades 122, 123 along the wall 11 of the main air duct 11 until the guide portion 110 abuts against the inner rim of the associated secondary air discharge opening 12.

At the end of the sliding step, the central blade 121 exerts a frictional force on the outer surface 11_{E} of the wall 11 and the lateral blades 122, respectively exert a frictional force on the inner surface 111 of the wall 11.

Thus, it appears that the assembly of an air orientation device, according to the first embodiment of the proposed technique, on a main air duct is easy, not very time-consuming and does not require any tooling.

It is also clear that the wall 11 of the main air duct undergoes a reversible change in shape between a first, so-called coupling position and a second, so-called immobilisation position.

The coupling position corresponds to a position wherein the wall 11 is not stressed, i.e. the wall is not elastically deformed, and the primary and secondary blades 121, 122, 123 are engaged with the outer and inner surfaces 11_{E}, 11_{I} respectively of the wall 11.

The immobilisation position corresponds to a position wherein, after the sliding of the removable fastening means, the wall 11 is elastically deformed by the pressure exerted by each of the primary and secondary blades 121, 122, 123.

Moreover, in order to make assembly simpler, a guiding step, conducted prior to the steps described hereinabove, for guiding the lateral blades 122, 123 can be considered.

The guiding step consists of pressing the free end 121_{A} of the primary blade 121 against the outer surface 11_{E} of the wall 11 of the main air duct 10 in a non-recurrent manner so as to move the primary blade 121 (by elastic deformation thereof) away from the secondary blades 122, 123. Thus, the insertion and engagement steps can be achieved by progressively folding the air orientation device 100 back towards the wall 11.

The extraction of the air orientation device is carried out by performing the steps described hereinabove in reverse order.

More specifically, the extraction of the air orientation device is achieved by a 90° pivot/rotation thereof so as to bring the joint plane P of the primary and secondary blades 121, 122, 123 perpendicular to the longitudinal axis A_{R} of the main air duct. Thus, the discharge opening 12 is temporarily elastically deformed to allow the additional retaining means to pass and thus to allow the primary and secondary blades 121, 122, 123 to be extracted. Such an extraction of the air orientation device 100 is preferably carried out by a lateral swinging motion, from left to right, accompanied by a backward pull (i.e. in the opposite direction to the direction in which the blades project).

### 5.3 Alternative Embodiments and Optional Features

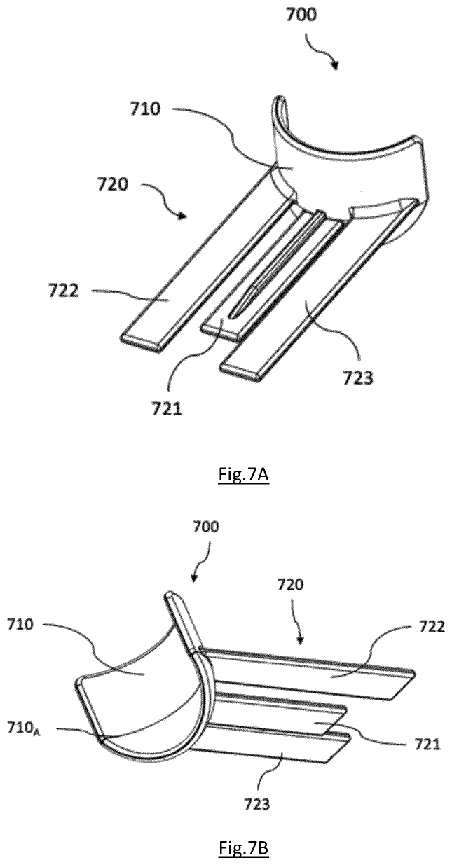

FIGS. 7A and 7B illustrate, from different perspective views, an example of an air orientation device according to a second advantageous embodiment of the proposed technique.

In this second embodiment, the air orientation device 700, made of a rigid material, comprises a guide portion 710 having a cross-section shaped in an arc of a circle such that it can be pressed against the inner rim of a circular air discharge opening.

The air orientation device 700 comprises a guide scoop 730 provided in the continuation of the lower end 710A of the guide portion 710. The guide scoop 730 is configured to be inserted through an air discharge opening provided in the wall of an air duct and to project into the interior volume of the main air duct. Such a guide scoop 730 thus increases the flow rate of the secondary air flow exiting through the air discharge opening coupled to the orientation device 700.

In this embodiment, the removable fastening means 720, allowing a local force to be exerted, immobilising the device by friction on the wall of the main air duct, comprise three blades 721, 722, 723 substantially parallel to one another and extending at least partially in a single fastening plane. The removable fastening means 720 thus comprise a primary blade 721, referred to as the central blade, and two secondary blades 722, 723, referred to as the lateral blades.

The central blade 721 is configured to be engaged with an inner surface of the flexible, elastically deformable wall of the air duct, whereas the lateral blades 722, 723 are configured to be engaged with an outer surface of the wall of this same air duct, after the central blade 721 has been inserted through an air discharge opening.

The assembly of the air orientation device 700 on a wall of a duct comprising at least one discharge opening for a secondary air flow comprises the following steps of:
inserting, from outside the air duct, the central blade 721 through the discharge opening;
engaging the central blade 721 with an inner surface of the wall of the air duct and engaging the lateral blades 722, 723 with an outer surface of the flexible wall of the air duct; and
sliding the blades 771, 722, 723 along the wall of the air duct until the guide portion abuts against an inner rim of the discharge opening.

In this embodiment, the wall of the main air duct also undergoes a reversible change in shape between a first, so-called coupling position and a second, so-called immobilisation position. The coupling position corresponds to a position wherein the wall is not stressed and the primary and secondary blades 721, 722, 723 are engaged with the inner and outer surfaces respectively of the wall. The immobilisation position corresponds to a position wherein, after the sliding of the removable fastening means, the wall is elastically deformed by the pressure exerted by each of the primary and secondary blades 721, 722, 723.

Moreover, in order to make assembly simpler, an optional guiding step, conducted prior to the steps described hereinabove, for guiding the primary and secondary blades 721, 722, 723 can be considered. The pressure exerted in a non-recurrent manner by the free ends of the secondary blades 722, 723 against the outer surface of the wall of the main duct causes a mild elastic deformation of the secondary blades. Thus, the insertion and engagement steps can be carried out by progressively folding the air orientation device 700 back towards the wall.

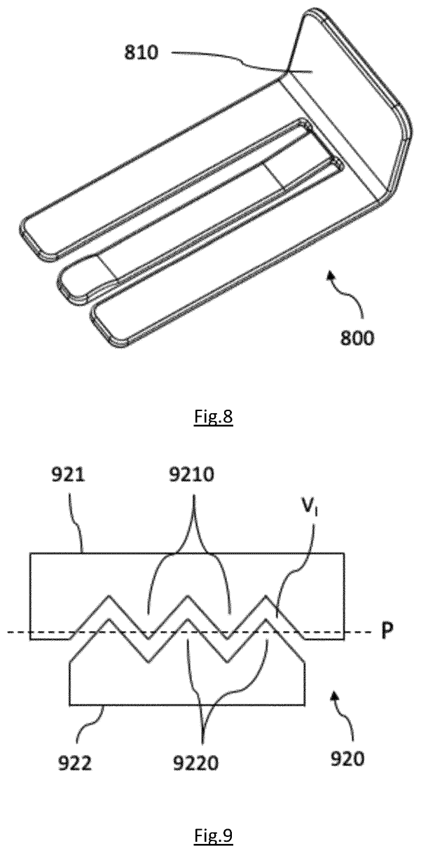

FIG. 8 shows a perspective, elevated view of an example of an air orientation device according to a third advantageous embodiment of the proposed technique.

This third embodiment differs from the first embodiment in the structure of the air orientation device 800, and mainly in the implementation of a planar guide portion 810 which allows it to be pressed against the inner contour of a rectangular air discharge opening.

The assembly of an air orientation device 800 on a wall of a main air duct is carried out by a similar assembly method to that described with reference to the second embodiment.

Thus, in a manner similar to the second embodiment, the wall of the main air duct also undergoes a reversible change in shape between a first, so-called coupling position and a second, so-called immobilisation position. The same applies for the secondary (lateral) blades.

FIG. 9 is a cross-sectional view of the removable fastening means, along the longitudinal axis thereof, of an example of an air orientation device according to a fourth advantageous embodiment of the proposed technique.

In this fourth embodiment, the air orientation device, made of a rigid material, has removable fastening means 920 comprising a primary blade 921 and a secondary blade 921 substantially parallel to one another and extending at least partially in a single fastening plane P. The primary and secondary blades 921, 922 are disposed opposite one another, and are spaced apart by an intermediate void Vi, so as to form an upper blade 921 and a lower blade 922.

The surfaces of the upper blade 921 and lower blade 922 facing the opposite blade respectively carry a plurality of projections 9210, 9220 oriented towards the opposite blade. The projections 9210, 9220 of the upper blade 921 and lower blade 922 are disposed in staggered rows and extend so as to be at least partially in a single fastening plane P.

The plurality of projections 9210 of the upper blade 921 are configured to be engaged with an outer surface of the flexible, elastically deformable wall of a main air duct and the plurality of projections 9220 of the lower blade 922 are configured to be engaged with an inner surface of the wall of the same main air duct, after the lower blade 922 has been inserted through an air discharge opening.

Such a structure in particular improves the mechanical strength of the removable fastening means, and thus minimises the risks of deterioration, or even destruction, thereof due, for example, to being accidentally hit by users. Such a structure further allows the frictional force of the removable fastening means to be evenly distributed over a determined portion of the wall of a main air duct. This reduces the risk of stress concentrations occurring on the wall of an air duct, which could permanently degrade the structure thereof, for example.

In the example shown, the upper and lower blades 921, 922 respectively have five and three projections. It is clear that a person skilled in the art will know how to adapt the number of projections, in particular as a function of the dimensioning of the air discharge opening that must cooperate with the air orientation device 900.

The assembly of the air orientation device 900 on a wall of a duct comprising at least one discharge opening for a secondary air flow comprises the following steps of:
inserting, from outside the air duct, the lower blade 922 through the discharge opening;
engaging the projections 9220 of the lower blade 922 with an inner surface of the wall of the air duct and engaging the projections 9210 of the lower blade 921 with an inner surface of the flexible wall of the air duct;
sliding the blades 921, 922 along the wall of the air duct until the guide portion 910 abuts against an edge of the discharge opening.

In this fourth embodiment, the wall of the main air duct also undergoes a reversible change in shape between a first, so-called coupling position and a second, so-called immobilisation position. The coupling position corresponds to a position wherein the wall is not stressed and the upper and lower blades 921, 922 are engaged with the outer and inner surfaces respectively of the wall. The immobilisation position corresponds to a position wherein, after the sliding of the removable fastening means 920, the wall is elastically deformed by the succession of bilateral pressures exerted by the projections 9210, 9220.

According to another solution, the lower and upper blades can be mildly convergent so as to locally produce, in addition to a frictional force, a pinching force on the wall of the air duct.

According to yet another solution, the lower and upper blades can be convergent and devoid of projections so as to produce a local immobilisation force immobilising the air orientation device by pinching the wall of the main air duct.

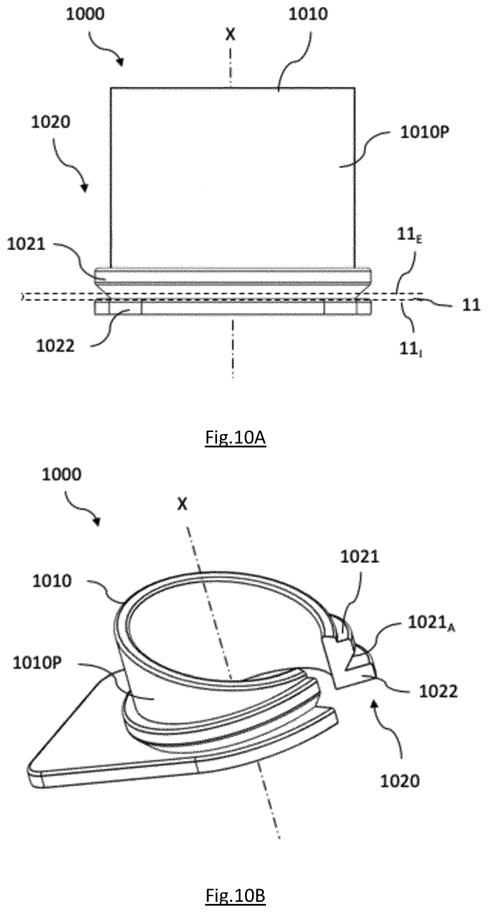

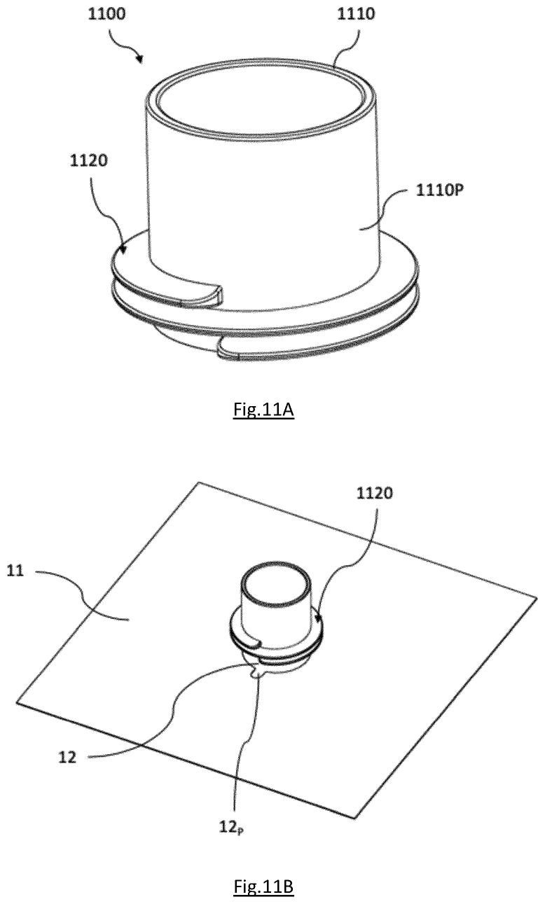

FIGS. 10A and 10B illustrate, from different views, an example of an air orientation device according to a fifth embodiment of the proposed technique.

In this fifth embodiment, the air orientation device differs from the first embodiment in particular in the nature of the material forming the air orientation device.

More specifically, in this fifth embodiment, the air orientation device 1000 is made in one piece of a shape-memory material having elastic properties. Preferably, the air orientation device 1000 is made, in whole or in part, of an elastomer material, such as polyurethane for example.

Such an air orientation device 1000 comprises a substantially annular guide portion 1010 having an area with an open or recessed sector of a circle along the longitudinal axis X of the guide portion 1010. In other words, the guide portion 1010 has a substantially “c”-shaped cross section. According to another solution, the guide portion is devoid of any such recess such that the blades, described hereinbelow, are circular and parallel.

Such a recess simplifies, as will become apparent hereafter, the deformation of the guide portion 1010, by a pinching force exerted by the user, so as to simplify the assembly of the air orientation device 1000 on the wall 11 of a main air duct.

The removable fastening means 1020 comprise a primary blade 1021 and a secondary blade 1022 provided, one above the other, on the outer peripheral wall 1010P of the guide portion 1010 so as to form an upper blade 1021 and a lower blade 1022. Moreover, the upper blade 1021 has a bevelled surface 1021A facing the lower blade 1022.

The bevelled surface 1021A of the upper blade 1021 is configured to be engaged with at least the outer rim of the air discharge opening provided in the rigid wall 11 of the main air duct. Preferably, the bevelled surface 1021A of the upper blade 1021 is configured to be pressed against the inner rim of the discharge opening (not visible), i.e. the face of the opening connecting the inner and outer surfaces 11_{I}, 11_{E} of the wall 11 of the air duct.

Thus, the removable fastening means 1020 substantially form a holding groove configured to receive the wall 11 of the main air duct.

The lower blade 1022 is configured to be engaged with the inner surface 11_{I} of the wall 11 of the same air duct.

Such a configuration allows the removable fastening means 1020 to exert a local immobilisation force, immobilising the removable fastening device 1020 on the wall 11 of the main air duct, by elastically returning the device to an immobilising or locking position in the discharge opening.

The assembly of the air orientation device 1000 on the wall 11 of the main air duct comprising at least one discharge opening (not visible) for a secondary air flow comprises the following steps of:
compressing the guide portion 1010 and the removable fastening means 1020 carried by the guide portion 1010, compression being achieved by a pinching force exerted by the user on the guide portion 1010;
inserting, from outside the duct, the lower blade 1022 through the discharge opening; and
relaxing the guide portion 1010 and the removable fastening means 1020 carried by the guide portion 1010, relaxation being achieved by releasing the pinching force exerted by the user on the guide portion 1010.

Thus, the removable fastening means 1020 of the air orientation device 1000 undergo a reversible change in shape between a first, so-called coupling position and a second, so-called immobilisation position.

The coupling position corresponds to a position wherein the air orientation device 1000, deformed by the compression exerted by the user, is partially disposed through the discharge opening.

The immobilisation position corresponds to a position wherein the removable fastening means 1020 exert, once the pinching force exerted by the user has been released, a pressing force on the contour of the discharge opening so as to immobilise the air orientation device 1000.

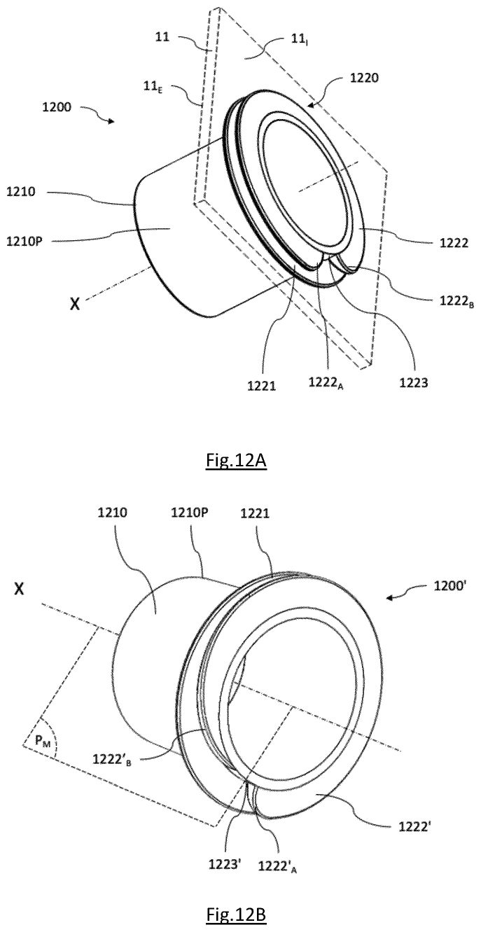

FIGS. 11A and 11B illustrate, from different views, an example of an air orientation device according to a sixth embodiment of the proposed technique.

In this sixth embodiment, the air orientation device 1100 comprises a guide portion 1110 that is tubular in shape and that has an annular cross-section. The guide portion 1110 has a diameter that is equal to or substantially less than the diameter of the discharge opening 12 intended to receive the air orientation device 1110.

The air orientation device 1100 further comprises removable fastening means 1120 formed by a blade that extends helically on the outer peripheral wall 1110P of the guide portion 1110. The helical blade is intended to be engaged with the wall 11 of the main air duct in order to provide friction immobilisation, reversibly fastening the air orientation device 1100 on the wall 11.

Such an air orientation device 1100 is configured to be reversibly fastened to the wall 11 of a main air duct by a screwing force.

Furthermore, in order to simplify the insertion and fastening of the air orientation device 1100 on the wall 11, the air discharge opening 12 comprises a local extension 12_{P}. Such an extension 12_{P}, forming a notch, is configured to allow the removable fastening means, i.e. the helical blade 1120 in this embodiment, to pass.

However, the extension 12_{P} of the air discharge opening 12 has smaller dimensions than the helical blade 1120. Thus, the insertion of the helical blade 1120 into the extension 12_{P} causes an enlargement thereof, and thus an elastic deformation of the wall 11 of the main air duct. The discharge opening 12 thus has a reversible shape-change capability for changing shape between a first position, referred to as a coupling position, which is used for the transitional phase of reversible attachment and/or detachment of the air orientation device with the discharge opening, and a second position, referred to as an immobilisation position, which is taken up continuously when the air orientation device is attached to the discharge opening.

FIGS. 12A and 12B illustrate two examples of a reversibly-fastened air orientation device according to a seventh embodiment of the proposed technique.

In this seventh embodiment, the air orientation device 1200 is made in one piece of a rigid or shape-memory material having elastic properties. More specifically, if the wall 11 (shown via dashed lines for clarity purposes) of the main air duct is made of a flexible material, an air orientation device made of a rigid material is preferred. Conversely, if the wall 11 of the main air duct is made of a rigid material, an air orientation device made of a shape-memory material with elastic properties is preferred. The main air duct and the air orientation device can, of course, be made of such a shape-memory material.

The air orientation device 1200 comprises a guide portion 1210 that is tubular in shape and that has an annular cross-section.

Thus, the guide portion 1210 has an outer peripheral wall 1210P of a predetermined outer diameter. The value of the outer diameter of the guide portion 1210 is determined such that it substantially corresponds to the value of the diameter of the discharge opening (not visible), provided in the wall 11 of the main air duct, intended to receive the air orientation device 1200. More specifically, if the air orientation device must be capable of moving in rotation within the discharge opening, the outer diameter of the guide portion 1210 will be slightly smaller than the inner diameter of the discharge opening. Conversely, if the air orientation device must be incapable of moving in rotation within the discharge opening, the outer diameter of the guide portion 1210 will be equal to or slightly larger than the diameter of the discharge opening. In the latter case, the value of the outer diameter of the guide portion 1210 is, of course, determined so as to ensure, via elastic deformation as will become apparent hereinbelow, the connection and disconnection of the air orientation device.

The removable fastening means 1220 comprise a primary blade 1221 and a secondary blade 1222 formed, one above the other, on the outer peripheral wall 1210P of the guide portion 1210 so as to form an upper blade 1221 and a lower blade 1222 situated in two parallel planes (not shown).

The upper blade 1221 and lower blade 1222, and thus the two parallel planes, are spaced apart from one another by a determined distance corresponding substantially to the thickness of the wall 11 of a main air duct. They thus form a space suitable for housing the peripheral edge of the wall 11 at the discharge opening 12.

More specifically, the upper blade 1221 extends integrally around the periphery of the outer peripheral wall 1210P of the guide portion 1210 so as to form a continuous upper flange 1221.

The lower blade 1222 extends partially around the periphery of the outer peripheral wall 1210P of the guide portion 1210 so as to form a discontinuous lower flange 1222 having two free ends 1222_{A}, 1222_{B}. Such a discontinuity in the lower flange 1222 is due to the presence of a through-notch (or cut-out) 1223 which locally removes the extra thickness formed by the blade and thus exposes the outer peripheral wall 1210P of the guide portion 1210.

Each of the upper and lower flanges 1222 thus increase the outer diameter of the guide portion 1210 which is thus locally larger than the diameter of the discharge opening provided in the wall 11 of the main air duct.

The notch 1223 allows for the assembly and disassembly of the air orientation device 1200 by allowing the lower flange 1222 to be gradually inserted and extracted through an air discharge opening provided in the wall of the main air duct 11.

More specifically, the assembly of the air orientation device 1200 on the wall 11 of the main air duct, comprising at least one discharge opening for a secondary air flow, comprises the following steps of:
inserting, from outside the duct, a first of the two free ends 1222A, 1222B of the lower flange 1222 through the discharge opening. Once this insertion is complete, a portion of the lower flange 1222, i.e. the first of the two free ends 1222A, 1222B, is located inside the main air duct and the upper flange 1221 partially rests on an outer surface 11_{E} of the wall 11 of the main air duct, and
rotating the air orientation device 1200 until the second of the free ends 1222A, 12228 of the lower flange 1222 is inserted through the discharge opening, i.e. until the lower flange 1222 is fully inserted through the discharge opening.

At the end of this rotation, which substantially produces a screwing effect even though the flanges do not form a helical pitch, the upper flange 1221 is engaged with the outer surface 11_{E} of the wall 11 of the main air duct and the lower flange 1222 is engaged with an inner surface 111 of the wall 11 of the same main air duct. The wall 11 is thus trapped between the upper flange 1221 and lower flange 1222.

Such a rotation is made possible by the reversible shape-changing capabilities of the air orientation device 1200 and/or the wall 11 of the main air duct (depending on the nature of the materials used). More specifically, the stresses exerted by the lower flange 1222 on the rim of the discharge opening have the effect of causing a reversible elastic deformation of the wall 11 of the duct, and/or vice versa. This reversible elastic deformation is thus used to gradually insert the lower flange 1222 into the discharge opening. Then, when the lower flange 1222 has completely passed through the discharge opening to be disposed inside the main air duct, the lower flange and/or the wall 11 of the main duct, being no longer stressed by one another, respectively recover their initial shape. In other words, the discharge opening and/or the air orientation device thus have a reversible shape-change capability for changing shape between a first position, referred to as a coupling position, which is used for the transitional phase of reversible attachment and/or detachment of the air orientation device with the discharge opening, and a second position, referred to as an immobilisation position, which is taken up continuously when the air orientation device is attached to the discharge opening.

FIG. 12A illustrates a first illustrative example of this seventh embodiment of the proposed technique.

In this first illustrative example, the air orientation device 1200 is made of a rigid material, preferably a macromolecular plastic material, such as polyethylene terephthalate, advantageously having the following properties: high resistance to corrosion, chemical agents, ultraviolet rays, sufficient flexibility to allow for insertion through the wall, and a high mechanical strength. However, any other plastic material with such properties, such as polypropylene, polyoxymethylene or a polyamide for example, can also be considered. Also preferably, the air orientation device is made of a thermoplastic material, so as to be manufactured by injection moulding or printing, having such properties inherently and/or by way of further treatment.

The guide portion 1210 of the air orientation device 1200 extends along the longitudinal axis X. The guide portion 1210 thus has an outer peripheral wall 1210P that has a right annular cylindrical shape.

The upper and lower flanges 1221, 1222, located at a longitudinal end of the guide portion 1210, project radially from the outer peripheral wall 1210P, i.e. perpendicular to the longitudinal axis X.

In this first illustrative example, the two ends 1222A, 1222B, delimited by the notch 1123, are symmetrical to one another relative to a median plane passing through the axis X and the middle of the notch 1223. Thus, the lower flange 1222 has two symmetrical opposing edges.

More specifically, the two ends 1222A, 12228 converge towards one another in the direction of the outer peripheral wall 1210P of the guide portion 1210. The two ends 1222A, 1222B are inclined and/or rounded.

Such symmetry simplifies the assembly of the air orientation device on the wall of the main air duct by allowing the device to be rotated both clockwise and anticlockwise. The same applies to the disassembly of the air orientation device, which can be carried out in either of the aforementioned two directions of rotation.

Moreover, the ends 1222A, 1222B are curved outwards, i.e. they are convex, as viewed from the interior of the guide portion 1210.

Such a shape of the ends of the lower flange avoids the formation of junction angles that could degrade, for example tear, the flexible wall of the main duct during the rotation of the air orientation device. Similarly, if the main air duct is rigid, such a shape of the ends of the lower flange avoids, or at least minimises, degradation of the device. This thus gives the main air duct and/or the air orientation device high durability.

FIG. 12B illustrates a second example of this seventh embodiment of the proposed technique. As will become apparent hereinbelow, the second example (FIG. 12B) differs from the first example (FIG. 12A) only in the structure of the ends of the lower flange. The elements common thereto will thus not be repeated in the description of this second example and will be referred to by the same reference numerals in FIGS. 12A and 12B.

In this second example, the lower flange 1222′ of the air orientation device 1200′ has two ends 1222′_{A}, 1222′_{B} delimited by the notch 1223′. Furthermore, the ends 1222′_{A}, 1222′_{B} are asymmetrical to one another relative to a median plane P_{M} passing through the axis X and the middle of the notch 1223′. Thus, the lower flange 1222′ has two asymmetrical opposing edges.

More specifically, the two ends 1222′_{A}, 1222′_{B} converge towards one another in the direction of the outer peripheral wall 1210P of the guide portion 1210. One of the ends, in this case the end 1222′_{B}, extends over a larger angular portion about the X axis than the end 1222′_{A}. In other words, the lower flange has one end that converges towards the outer peripheral wall 1210P of the guide portion 1210 more significantly than the other end, i.e. the more convergent end 1222′_{A} is shorter than the less convergent end 1222′_{B}, whose curvature is more gradual.

Such an asymmetry of the lower flange allows the more convergent end 1222′_{A}, referred to as the leading edge, to initiate the installation of the air orientation device 1200′ on the wall of the main air duct, whereas the less convergent end 1222′_{B}, referred to as the trailing edge, minimises the deformation of the wall of the main air duct before it recovers its initial shape. The trailing edge further simplifies the extraction of the air orientation device 1200′. The implementation thereof allows the orientation device to be installed and disassembled in a more gradual way.

Preferably, and as illustrated, the ends 1222′_{A}, 1222′_{B} are curved outwards as viewed from the interior of the guide portion 1210′, i.e. they are convex. However, planar ends can be considered in order to procure a uniform gradual deformation of the wall when assembling/disassembling the device on/from the main air duct.

Alternative embodiments to the illustrative examples described hereinabove can also be made to the air orientation device while remaining in accordance with the seventh embodiment of the proposed technique.

For example, if the main air duct is made of a rigid material, the air orientation device can be made of polyurethane, i.e. of a shape-memory material having elastic properties.

According to another example, the guide portion can be curved in order to adjust the orientation of the secondary air flow, originating from the air discharge opening of the main air duct, in a predetermined direction that is different to that perpendicular to the longitudinal axis of the main air duct. In a further example allowing the orientation of the secondary air flow to be adjusted, the upper and lower flanges can be inclined relative to the longitudinal axis of the guide portion. Thus, when the air orientation device is assembled on the main air duct, the guide portion of the device is substantially inclined relative to the longitudinal axis of the duct. In another alternative embodiment, the guide portion could be flexible to allow the orientation thereof to be changed relative to the surface of the wall 11 of the duct.

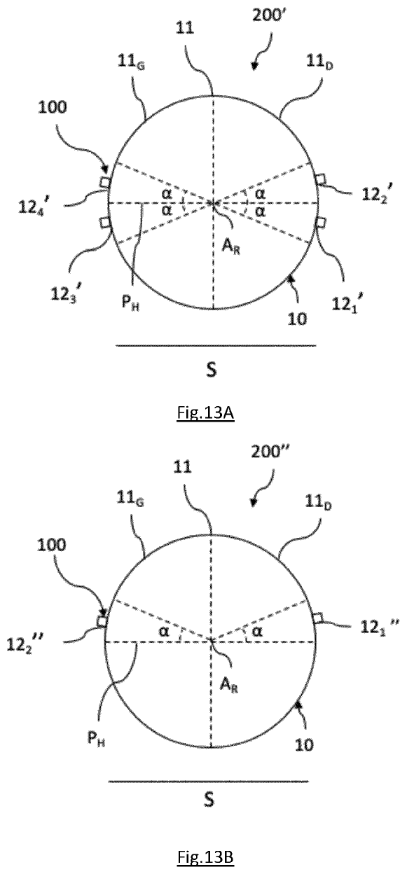

FIGS. 13A and 13B illustrate two examples of the distribution of the secondary air discharge openings on the main air duct that are an alternative to the example illustrated in FIG. 3.

Similarly to the example illustrated in FIG. 3, the alternative examples illustrated in FIGS. 13A and 13B respectively show a duct and distribution assembly 200′, 200″ comprising a main air duct 10, having a tubular shape and annular section, with an axis of revolution A_{R} that extends in a horizontal plane P_{H}.

Moreover, each secondary air discharge opening 12 is provided in the wall 11 of the main air duct 10 in at least one sector of angle α, comprised between 0° and 45°, preferably between 0° and 30°, to the horizontal plane P_{H}.

In the example illustrated in FIG. 13A, the main air duct 10 has four sectors of angle α relative to the horizontal plane P_{H}, i.e. a lower right sector, an upper right sector, a lower left sector and an upper left sector.

The main air duct 10 further has four sets of discharge openings 12₁′, 12₂′, 12₃′, 12₄′ respectively located in the lower right sector, the upper right sector, the lower left sector and the upper left sector.

The example illustrated in FIG. 13B differs from the example illustrated in FIG. 13A, by the implementation of two sets of discharge openings 12₁″, 12₂″ respectively located in the upper right sector of angle α and upper left sector of angle α.

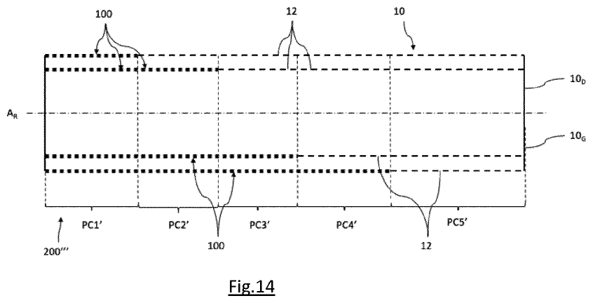

FIG. 14 illustrates a diagrammatic top view of a duct and air distribution assembly according to an alternative embodiment.

This alternative embodiment differs from the embodiment shown with reference to FIGS. 2 and 4 in particular by an asymmetrical distribution, relative to the axis of revolution of the main air duct, of the reversibly-fastened air orientation devices on the secondary air discharge openings.

More specifically, in this alternative embodiment, the duct and air distribution assembly 200′″ comprises air orientation devices 100 fitted to the secondary air discharge openings 12 of the main air duct 10 asymmetrically, relative to a vertical plane passing through the axis of revolution A_{R} of the main air duct 10.

Such an asymmetrical distribution of the orientation devices 100 allows the orientation of the secondary air flows on each side of the main air duct 10 to be oriented differently according to the structure of the building defining the enclosed or semi-enclosed interior volume and/or the needs of the bodies occupying this interior volume in particular.

In the illustrated example, the main air duct 10, which has a right lateral part 10_{D} and a left lateral portion 10_{G} relative to the vertical plane passing through the axis of revolution A_{R} thereof, is notionally separated into five longitudinal areas PC1′, PC2′, PC3′, PC4′, PC5′ respectively succeeding one another.

In the right-hand part 10_{D} of the main air duct 10, only some or all of the discharge openings 12 of the first and second longitudinal areas PC1′, PC2′ are equipped with orientation devices 100. In the left-hand part 10_{G} of the same main air duct 10, only some or all of the discharge openings 12 of the first to fourth longitudinal areas PC1′ to PC4′ of the duct are equipped with orientation devices 100.

Thus, a duct and air distribution assembly 200′″ with such an asymmetrical distribution of the orientation devices 100 favours the orientation and guidance of secondary air flows in the left-hand lateral part 10_{G} of the main air duct 10.

According to another solution, in at least one longitudinal area of the tubular main air duct, the secondary air discharge openings are provided on the main air duct asymmetrically relative to a vertical plane passing through the axis of revolution of the main air duct. The asymmetry can in particular be due to different shapes and/or dimensions of the secondary air discharge openings. Such asymmetry of the secondary air discharge openings in particular makes it possible to adapt the flow rate and/or propagation of secondary air within an enclosed or semi-enclosed interior volume.

With regard to the various example embodiments described, it appears that the reversible change in shape between a first, so-called coupling position, and a second, so-called immobilisation position, is achieved by the wall of the main air duct or by the removable fastening means. In another solution, the reversible change in shape can be achieved by the wall of the main air duct and by the removable fastening means simultaneously or sequentially.

The installation of an assembly in accordance with the proposed technique in a greenhouse for growing plants comprises, for example, and in this order of preference, the following steps of:
installing a fan in a predetermined area of the greenhouse;
connecting the fan to a first longitudinal end of a main duct that is tubular, that may or may not be tiered, and having openings, that may or may not be identical, uniformly or asymmetrically distributed, longitudinally and radially, on the wall thereof;
connecting a cover to the opposite longitudinal end of the duct;
reversibly fastening removable air deflectors provided with removable fastening means such as blades (or “skis”) on all or part of the openings of the duct by performing the following actions, for each deflector:
inserting, from the outside of the duct, at least one first blade (or ski) through the opening;
   engaging the first ski (or blade) with an inner surface of the wall and engaging at least one second ski with an outer surface of the wall;
   sliding or pivoting the skis until the air deflector is immobilised on the duct.

Thus, each air deflector, configured to orient the associated air jet in a direction as perpendicular as possible to the axis of the duct to prevent this air mass from moving along the duct inducing a temperature and humidity imbalance, is easy to assemble and disassemble on/from the duct. This results in a customised design of the ducts to suit the user's preferences, since the adjustable and changeable positioning of the deflectors allows for a wider range of initial configurations for the duct and the openings thereof, as well as more possibilities according to the changing operating environment.

It goes without saying that the proposed technique is not limited to the embodiments described hereinabove, which are provided by way of example only. It encompasses various modifications, alternative forms and other alternative embodiments that a person skilled in the art could envisage within the scope of this invention and in particular any combinations of the different modes of operation described hereinabove, which can be taken separately or in combination.

For example, a person skilled in the art will be able to dispose, in a duct and air distribution assembly according to the invention, shut-off devices instead of certain air orientation devices. A shut-off device can, for example, be designed in a similar way to an air orientation device, while replacing the guide portion with a shutter portion, i.e. means for closing the air discharge opening provided in the wall of a main air duct, and wherein the shutter device has been placed. In other words, such a shut-off device comprises, on the one hand, a shut-off portion configured to shut said discharge opening, and on the other hand, removable fastening means configured to reversibly fasten the shut-off portion to the wall of the main air duct. The removable fastening means of the air shut-off device are advantageously the same or similar to the removable fastening means of the air orientation device of the proposed technique.

More generally, the invention encompasses all implementations of the principle whereby the air conditioning ducts of a greenhouse are equipped with removable air deflectors when being installed.

The solution of the proposed technique thus procures, according to the embodiments, an air orientation device reversibly fastened to a main air duct by means of removable fastening means so as to simplify handling, initial installation and subsequent modification of the installation.

According to various aspects, the proposed technique thus has some or all of the following advantages, depending on the embodiments chosen:
it allows the air orientation devices to be fastened before or after installation of the main air duct in the enclosed or semi-enclosed interior space;
the air orientation devices can be fastened in a simple and efficient manner;
it adapts to standard or existing main air ducts;
the orientation of the flows can be varied according to the structure of the main air duct;
the main air duct assembly can be optimised;
it is highly durable;
it requires limited maintenance;
maintenance is simplified;
the air orientation devices can be fastened without the need for tooling;
etc.

1. An air orientation device to be coupled to an air discharge opening provided in a wall of a main air duct, the air orientation device comprising:
a guide portion configured to guide a secondary air flow originating from said discharge opening; and′
removable fastener which reversibly fastens said guide portion to said wall of the main air duct.

2. The air orientation device according to claim 1, wherein said removable fastener is configured to exert a local force for immobilising said device by producing friction on said wall of the main air duct.

3. The air orientation device according to claim 1, wherein the removable fastener of the air orientation device have a reversible shape-change capability for changing shape between a first position, referred to as a coupling position, which is used for a transitional phase of reversible attachment and/or detachment of the air orientation device with a discharge opening, and a second position, referred to as an immobilisation position, which is taken up continuously when the air orientation device is attached to a discharge opening.

4. The air orientation device according to claim 1, wherein said removable fastener is configured to exert a local force for immobilising said device by pinching said wall of the main air duct.

5. The air orientation device according to claim 1, wherein said removable fastener comprises at least one blade engageable with said wall of the main air duct to produce a removable fastening friction.

6. The air orientation device according to claim 5, wherein said removable fastener comprises at least two blades substantially parallel to one another and extending at least partially in a single fastening plane so as to define a primary blade and at least one secondary blade, said at least two blades being engageable via an elastic connection with said wall of the main air duct to produce a removable fastening friction.

7. The air orientation device according to claim 6, wherein said guide portion extends along a longitudinal axis, and said primary blade and said secondary blades are integral with a longitudinal end of said guide portion.

8. The air orientation device according to claim 6, wherein said guide portion has a tubular shape, and said primary blade and said lateral blades extend perpendicular to a longitudinal axis of said guide portion.

9. The air orientation device according to claim 1, further comprising an additional retainer configured to reversibly fasten said guide portion on said wall of the main air duct in a manner that complements a fastening friction by the fastener.

10. The air orientation device according to claim 9, wherein said additional retainer comprises first and second projections extending on either side of said guide portion so as to locally widen said guide portion.

11. The air orientation device according to claim 10, wherein:
said removable fastener comprises at least two blades substantially parallel to one another and extending at least partially in a single fastening plane so as to define a primary blade and at least one secondary blade, said at least two blades being engageable via an elastic connection with said wall of the main air duct to produce a removable fastening friction; and
each of said secondary blades carries one of said projections forming the additional retainer.

12. The air orientation device according to claim 1, wherein said guide portion has a tubular outer peripheral wall and said removable fastener comprises first and second flanges parallel to one another and integral with said outer peripheral wall of said guide portion so as to define an upper flange spaced apart from a lower flange, said lower flange having a notch to allow said wall of the main air duct to pass between said upper and lower flanges.

13. The air orientation device according to claim 12, wherein said flanges are at a distance from one another along an axis of said guide portion and delimit a space therebetween suitable for housing a peripheral edge of said wall.

14. The air orientation device according to claim 12, wherein said guide portion has an annular section.

15. The air orientation device according to claim 12, wherein said lower flange is flush with one end of said guide portion.

16. The air orientation device according to claim 12, wherein the air orientation device is made in one piece.

17. The air orientation device according to claim 12, wherein said lower flange has two free ends, delimiting said notch, and said ends are symmetrical relative to a median plane passing through an axis of said guide portion located between said ends.

18. The air orientation device according to claim 12, wherein said lower flange has two free ends, delimited by said notch, and said ends are asymmetrical relative to a median plane passing through an axis of said guide portion located between said ends.

19. The air orientation device according to claim 17, wherein said ends converge towards one another in the direction of said outer peripheral wall of the guide portion.

20. The air orientation device according to claim 17, wherein said ends are convex in shape.

21. A duct and air distribution assembly comprising:
a main air duct comprising a wall which has a plurality of secondary air discharge openings therethrough; and
at least one secondary air orientation device coupled to one of said discharge openings, each air orientation device comprising a guide portion for guiding a secondary air flow originating from said discharge opening associated with said air orientation device and a removable fastener which removably fastens said guide portion to said wall of the air duct.

22. (canceled)

23. The duct and air distribution assembly according to claim 21, wherein said plurality of discharge openings are distributed along said main air duct having a predetermined length, and each discharge opening located in a first longitudinal area of said main air duct carries an air orientation device.

24. The duct and air distribution assembly according to claim 23, wherein said first longitudinal area has a length comprised between one fifth and one half of the length of said main air duct, and said first longitudinal area is located at a longitudinal end of the main air duct, said longitudinal end of the main air duct being intended to be coupled to a central air conditioning unit.

25. The duct and air distribution assembly according to claim 23, wherein said main air duct comprises a second longitudinal area, which is separate from said first longitudinal area, wherein certain discharge openings respectively carry an air orientation device, and a third longitudinal area, which is separate from said first and second longitudinal areas, wherein the discharge openings are devoid of any air orientation device.

26. (canceled)

27. The air orientation device according to claim 18, wherein said ends converge towards one another in the direction of said outer peripheral wall of the guide portion.
